(19) United States
(12) Patent Application Publication
(10) Pub. No.: US 2016/0124624 A1
(43) Pub. Date: May 5, 2016

(54) ELECTRONIC DEVICE AND WEB PAGE RESIZING METHOD

(71) Applicant: Chiun Mai Communication Systems, Inc., New Taipei (TW)

(72) Inventor: PIN-WEI CHEN, New Taipei (TW)

(21) Appl. No.: 14/840,213

(22) Filed: Aug. 31, 2015

(30) Foreign Application Priority Data
Oct. 29, 2014 (CN) 201410596408.X

(51) Int. Cl. G06F 3/0484; G06F 3/0488

(52) U.S. Cl. CPC G06F 3/04847; G06F 3/0488

(57) ABSTRACT

A method of resizing a web page that is displayed on a touch screen of an electronic device includes detecting pressure operation on the touch screen. A further pressure operation is detected when the pressure operation is identified to be valid. The web page is resized according to the further pressure operation.

### CROSS-REFERENCE TO RELATED APPLICATIONS

This application claims priority to Chinese Patent Application No. 201410596408.X filed on Oct. 29, 2014, the contents of which are incorporated by reference herein.

### FIELD

The subject matter herein generally relates to management technology, and particularly to an electronic device and a method for resizing a web page using the electronic device.

### BACKGROUND

An electronic device, such as a mobile phone, can be used to browse a web page. Usually, the web page may has been resized according to a size of a touch screen of the electronic device, it may result that a size of content of the web page is not suitable (e.g., too large or too small) for a user.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a resizing system.

FIG. 2 is a block diagram of one embodiment of functional modules of the resizing system.

FIG. 3 illustrates a flowchart of one embodiment of a method for resizing a web page.

FIG. 4 illustrates a diagrammatic view of one example of enlarging a web page.

FIG. 5 illustrates a diagrammatic view of another example of enlarging a web page.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

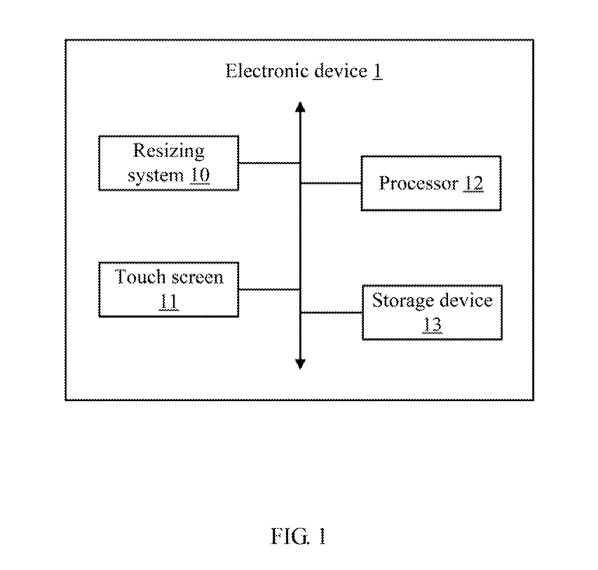

FIG. 1 is a block diagram of one embodiment of an electronic device. The electronic device can be a smart phone, a personal digital assistant (PDA), a tablet computer, or any other suitable electronic device. Depending on the embodiment, an electronic device 1 includes a resizing system 10, a touch screen 11, at least one processor 12, and a storage device 13. FIG. 1 illustrates only one example of the electronic device 1 that can include more or fewer components than illustrated, or have a different configuration of the various components in other embodiments.

The touch screen 11 can be a carbon-nanotube touch panel that is configured with pressure sensing elements. When there is a pressure operation on the touch screen 11, the touch screen 11 can obtain pressure information of the pressure operation such as a pressure value, and a pressure position. In at least one embodiment, the pressure operation may be a finger of a user pressing on the touch screen 11.

The at least one processor 12 can be a central processing unit (CPU), a microprocessor, or other data processor chip that performs functions of the electronic device 1.

The storage device 13 can be an internal storage device, such as a flash memory, a random access memory (RAM) for temporary storage of information, and/or a read-only memory (ROM) for permanent storage of information. The storage device 13 can also be an external storage device, such as an external hard disk, a storage card, or a data storage medium.

The resizing system 10 can resize a web page displayed on the touch screen 11 according to the pressure operation on the touch screen 11.

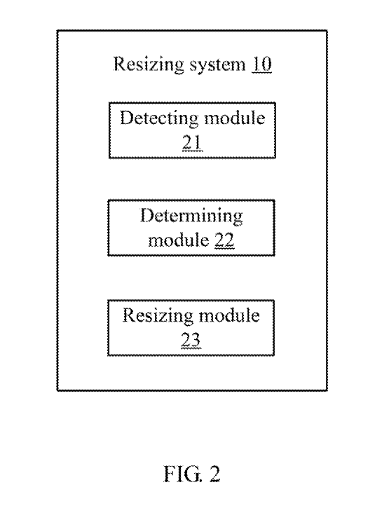

FIG. 2 is a block diagram of one embodiment of functional modules of the resizing system 10. In at least one embodiment, the resizing system 10 can include a detecting module 21, a determining module 22, and a resizing module 23. The function modules 21-23 can include computerized codes in the form of one or more programs, which are stored in the storage device 13, and are executed by the at least one processor 12 of the electronic device 1 to resize a web page. Details will be given in the following paragraphs.

When a web page is displayed on the touch screen 11 of the electronic device 1, the detecting module 101 can detect the presence of a pressure operation on the touch screen 11, and obtain pressure information of the pressure operation. The pressure information includes the pressure value and the pressure position of the pressure operation.

The determining module 22 can identify whether the pressure operation is valid.

In at least one embodiment, when the pressure value of the pressure operation is greater than a preset value, and a duration of the pressure operation is greater than a preset duration, the determining module 22 can identify the pressure operation is valid. For example, if the user presses a finger on the touch screen 11 with the pressure value that is greater than 5 Newtons (Ns) for more than 5 seconds, the determining module 22 can identify the pressure operation is valid.

The detecting module 21 can detect the presence of a further pressure operation when the pressure operation is valid. In at least one embodiment, the further pressure operation includes sliding on the touch screen 11 based on the pressure operation. In another embodiment, the further pressure operation includes keeping the pressure position of the pressure operation invariant on the touch screen 11 for a pre-set time period.

The resizing module 23 can resize the web page according to the further pressure operation.

In at least one embodiment, when the further pressure operation includes sliding on the touch screen 11 based on the pressure operation, the resizing module 23 can enlarge the web page a preset percentage when the further pressure operation slides upwards for a preset distance value, and reducing the web page the preset percentage when the further pressure operation slides downwards for a preset distance value. The preset percentage may be determined based on the preset distance value.

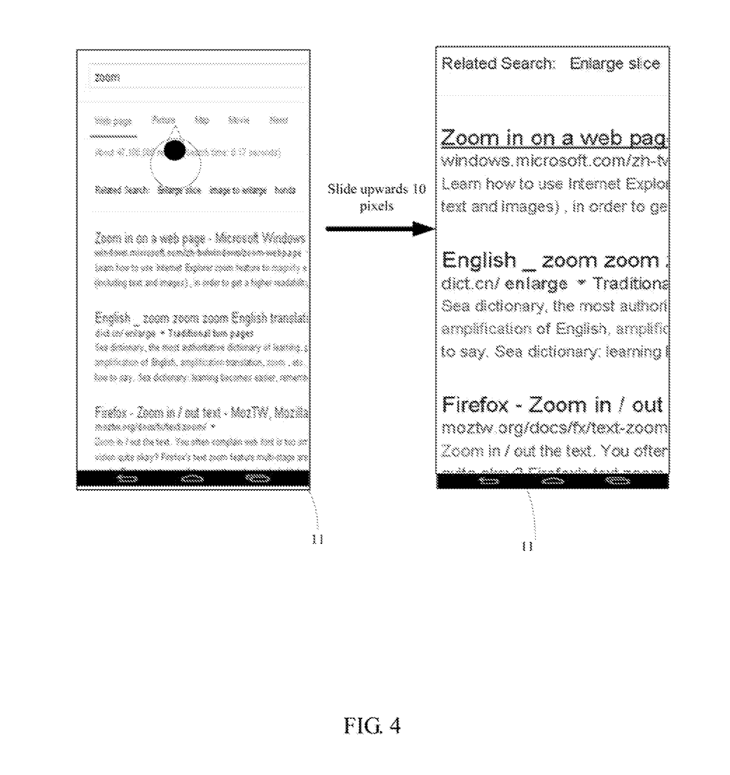

For example, FIG. 4 illustrates when the user slides the finger upwards on the touch screen 11 ten pixels, the resizing module 23 can enlarge the web page ten percent. When the user slides downwards on the touch screen 11 twenty pixels, the resizing module 23 can reduce the web page twenty percent.

In another embodiment, when the further pressure operation includes keeping the pressure position of the pressure operation invariant on the touch screen 11 for the preset time period, the resizing module 23 can enlarge the web page the preset percentage when the pressure position is above a middle position of the touch screen 11, and reduce the web page the preset percentage when the pressure position is not above the middle position of the touch screen 11. The pressure position is not above the middle position of the touch screen 11 means the pressure position is in the middle position of the touch screen 11, or below the middle position of the touch screen 11.

In at least one embodiment, when the pressure position is above the middle position of the touch screen 11, and is kept invariant on the touch screen 11, the resizing module 23 can enlarge the web page the preset percentage at each preset time interval. When the pressure position is not above the middle position of the touch screen 11, and is kept invariant on the touch screen 11, the resizing module 23 can reduce the web page the preset percentage at each preset time interval.

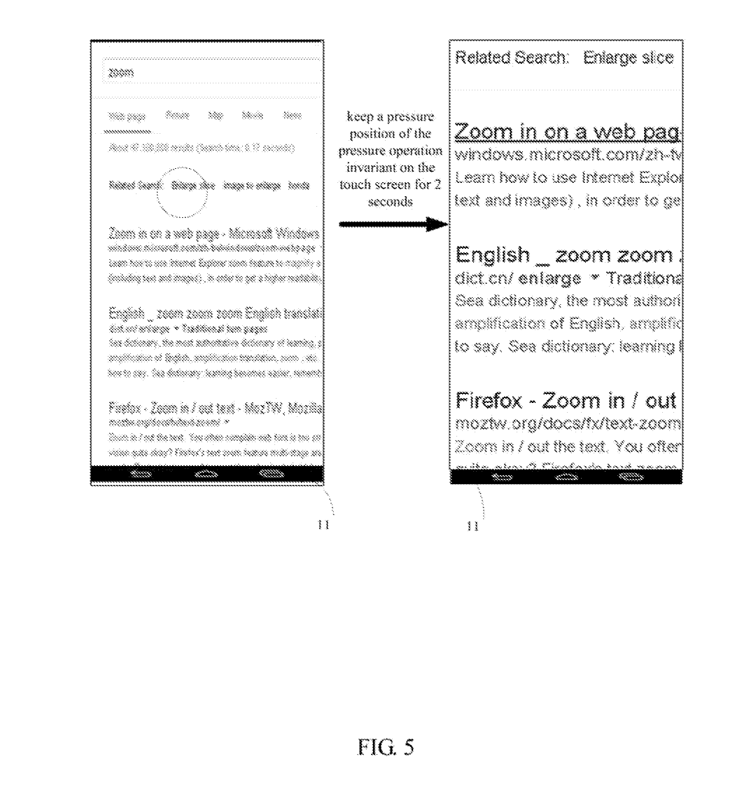

For example, FIG. 5 illustrates the resizing module 23 can enlarge the web page ten percent every two seconds, when the pressure position of the pressure operation is above the middle position of the touch screen 11, and is kept invariant on the touch screen 11.

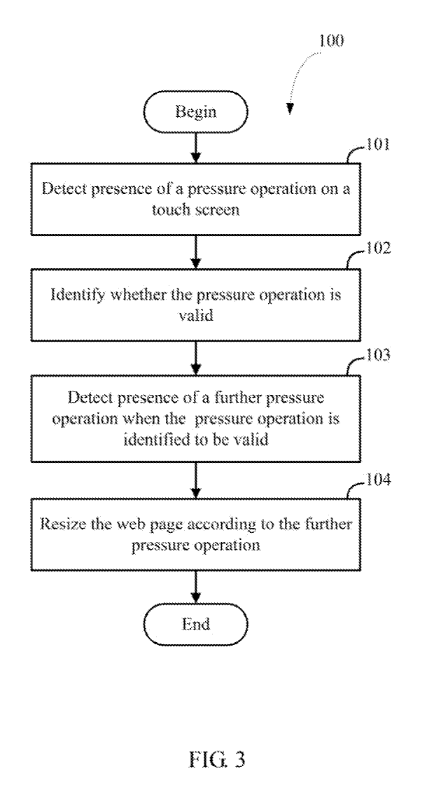

FIG. 3 illustrates a flowchart is presented in accordance with an example embodiment. The example method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 2 represents one or more processes, methods or subroutines, carried out in the exemplary method 100. Additionally, the illustrated order of blocks is by example only and the order of the blocks can be changed according to the present disclosure. The exemplary method 100 can begin at block 101. Depending on the embodiment, additional steps can be added, others removed, and the ordering of the steps can be changed.

At block 101, when a web page is displayed on a touch screen of an electronic device, a detecting module can detect the presence of a pressure operation on the touch screen, and obtain pressure information of the pressure operation. The pressure information includes the pressure value and the pressure position of the pressure operation.

At block 102, a determining module can identify whether the pressure operation is valid. In at least one embodiment, when the pressure value of the pressure operation is greater than a preset value and a duration of the pressure operation is greater than a preset duration, the determining module can identify that the pressure operation is valid. For example, if the user presses a finger on the touch screen with the pressure value that is greater than 5 Newtons (Ns) for more than 5 seconds, the determining module can identify the pressure operation is valid.

At block 103, the detecting module can detect the presence of a further pressure operation when the pressure operation is valid. In at least one embodiment, the further pressure operation includes sliding on the touch screen based on the pressure operation. In another embodiment, the further pressure operation includes keeping the pressure position of the pressure operation invariant on the touch screen for a pre-set time period.

At block 104, a resizing module can resize the web page according to the further pressure operation.

In at least one embodiment, when the further pressure operation includes sliding on the touch screen based on the pressure operation, the resizing module can enlarge the web page a preset percentage when the further pressure operation slides upwards for a preset distance value, and reduce the web page with the preset percentage when the further pressure operation slides downwards for a preset distance value. The preset percentage may be determined based on the preset distance value.

For example, as shown in FIG. 4, when the user slides the finger upwards on the touch screen for ten pixels, the resizing module can enlarge the web page ten percent. When the user slides downwards on the touch screen for twenty pixels, the resizing module can reduce the web page twenty percent.

In another embodiment, when the further pressure operation includes keeping the pressure position of the pressure operation invariant on the touch screen for the preset time period, the resizing module can enlarge the web page with the preset percentage when the pressure position is above a middle position of the touch screen, and reduce the web page with the preset percentage when the pressure position is not above the middle position of the touch screen. The pressure position is not above the middle position of the touch screen means the pressure position is in the middle position of the touch screen, or below the middle position of the touch screen.

In at least one embodiment, when the pressure position is above the middle position of the touch screen, and is kept invariant on the touch screen, the resizing module can enlarge the web page the preset percentage at each preset time interval. When the pressure position is not above the middle position of the touch screen, and is kept invariant on the touch screen, the resizing module can reduce the web page the preset percentage at each preset time interval.

For example, FIG. 5 illustrates the resizing module can enlarge the web page ten percent every two seconds, when the touch position of the pressure operation is above the middle position of the touch screen, and is kept invariant on the touch screen.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for adjusting a web page using at least one processor of an electronic device, the web page displayed on a touch screen of the electronic device, the method comprising:
detecting presence of a pressure operation on the touch screen;
identifying whether the pressure operation is valid;
detecting presence of a further pressure operation when the pressure operation is identified to be valid; and
resizing the web page according to the further pressure operation.

2. The method according to claim 1, wherein the pressure operation is determined to be valid when a pressure value of the pressure operation is greater than a preset value and a duration of the pressure operation is greater than a preset duration.

3. The method according to claim 1, wherein when the further pressure operation comprises sliding on the touch screen based on the pressure operation, the web page is resized by:
enlarging the web page with a preset percentage when the further pressure operation slides upwards for a preset distance value; and
reducing the web page with the preset percentage when the further pressure operation slides downwards for the preset distance value.

4. The method according to claim 1, wherein when the further pressure operation comprises keeping a pressure position of the pressure operation invariant on the touch screen for a preset time period, the web page is resized by:
enlarging the web page with a preset percentage when the pressure position is above a middle position of the touch screen; and
reducing the web page with the preset percentage when the pressure position is not above the middle position of the touch screen.

5. The method according to claim 4, wherein the web page is resized by:
enlarging the web page with the preset percentage at each preset time interval when the pressure position is above the middle position of the touch screen and is kept invariant on the touch screen; and
reducing the web page with the preset percentage at the each preset time interval when the pressure position is not above the middle position of the touch screen and is kept invariant on the touch screen.

6. An electronic device comprising:
a touch screen that displays a web page;
at least one processor;
a storage device that stores images, the storage device being configured to store one or more programs that, when executed by the at least one processor, cause the at least one processor to:
detect presence of a pressure operation on the touch screen;
identify whether the pressure operation is valid;
detect presence of a further pressure operation when the pressure operation is identified to be valid; and
resizing the web page according to the further pressure operation.

7. The electronic device according to claim 6, wherein the pressure operation is determined to be valid when a pressure value of the pressure operation is greater than a preset value, and a duration of the pressure operation is greater than a preset duration.

8. The electronic device according to claim 6, wherein when the further pressure operation comprises sliding on the touch screen based on the pressure operation, the web page is resized by:
enlarging the web page with a preset percentage when the further pressure operation slides upwards for a preset distance value; and
reducing the web page with the preset percentage when the further pressure operation slides downwards for the preset distance value.

9. The electronic device according to claim 6, wherein when the further pressure operation comprises keeping a pressure position of the pressure operation invariant on the touch screen for a preset time period, the web page is resized by:
enlarging the web page with a preset percentage when the pressure position is above a middle position of the touch screen; and
reducing the web page with the preset percentage when the pressure position is not above the middle position of the touch screen.

10. The electronic device according to claim 9, wherein the web page is resized by:
enlarging the web page with the preset percentage at each preset time interval when the pressure position is above the middle position of the touch screen, and is kept invariant on the touch screen; and
reducing the web page with the preset percentage at the each preset time interval when the pressure position is not above the middle position of the touch screen, and is kept invariant on the touch screen.

11. A non-transitory storage medium having instructions stored thereon for resizing a web page that is displayed on a touch screen of an electronic device that, when executed by a processor of the electronic device, cause the electronic device to:
detect presence of a pressure operation on the touch screen;
identify whether the pressure operation is valid;
detect presence of a further pressure operation when the pressure operation is identified to be valid; and
resizing the web page according to the further pressure operation.

12. The non-transitory storage medium according to claim 11, wherein the pressure operation is determined to be valid when a pressure value of the pressure operation is greater than a preset value, and a duration of the pressure operation is greater than a preset duration.

13. The non-transitory storage medium according to claim 11, wherein when the further pressure operation comprises sliding on the touch screen based on the pressure operation, the web page is resized by:
enlarging the web page with a preset percentage when the further pressure operation slides upwards for a preset distance value; and
reducing the web page with the preset percentage when the further pressure operation slides downwards for the preset distance value.

14. The non-transitory storage medium according to claim 11, wherein when the further pressure operation comprises keeping a pressure position of the pressure operation invariant on the touch screen for a preset time period, the web page is resized by:
enlarging the web page with a preset percentage when the pressure position is above a middle position of the touch screen; and
reducing the web page with the preset percentage when the pressure position is not above the middle position of the touch screen.

15. The non-transitory storage medium according to claim 14, wherein the web page is resized by:
enlarging the web page with the preset percentage at each preset time interval when the pressure position is above the middle position of the touch screen, and is kept invariant on the touch screen; and
reducing the web page with the preset percentage at the each preset time interval when the pressure position is not above the middle position of the touch screen, and is kept invariant on the touch screen.
